(19) United States
(12) Patent Application Publication
(10) Pub. No.: US 2013/0250088 A1
(43) Pub. Date: Sep. 26, 2013

(54) MULTI-COLOR CONFOCAL MICROSCOPE AND IMAGING METHODS

(71) Applicant: Yuri V. Osipchuk, Foster City, CA (US)

(72) Inventor: Yuri V. Osipchuk, Foster City, CA (US)

(73) Assignee: MOLECULAR DEVICES, LLC, Sunnyvale, CA (US)

(21) Appl. No.: 13/427,489

(22) Filed: Mar. 22, 2012

(51) Int. Cl. H04N 7/18

(52) U.S. Cl. 348/79; 348/E07.085

(57) ABSTRACT

A confocal microscope, which comprises a light source for producing excitation light including a plurality of different spectral components; an optical device for providing the excitation light as a spectrally dispersed beam and outputting the different spectral components as a number of elongated beams an object holder for holding an object; an objective for focusing the elongated beams of light on the object as parallel, spaced-apart lines of excitation light corresponding to the different spectral components; and a detector for simultaneously detecting emission light produced by parallel lines emitted by the object due to its illumination by spaced apart parallel lines of the excitation light.

### TECHNICAL FIELD

The present invention generally relates to confocal microscopy, particularly confocal microscopy utilizing multi-color excitation light and line scanning.

### BACKGROUND

Confocal microscopes are considered to have advantages over wide-field microscopes in various imaging applications, primarily due to improved resolution and rejection of out-of-focus light, which allows confocal microscopes to perform optical “sectioning” of imaged objects. Confocal microscopes are thus useful, for example, in fluorescence microscopy. In fluorescence microscopy, the object (or sample) under investigation (typically a biological specimen) is labeled by one or more different types of fluorophores, which are the targets of the illumination by the microscope's light source. The fluorophores emit fluorescence photons in response to being illuminated at appropriate wavelengths. The confocal microscope collects the emitted photons to form an image of the object, allowing direct observation of various aspects of the object at the cellular level.

One type of confocal microscope is termed a line scanning (or slit, or bilateral) confocal microscope. Typically, a line scanning confocal microscope includes the following components. A lighting device serves as the source of electromagnetic radiation, or excitation light, which is directed to the object under investigation. The excitation light is produced in the form of an elongated beam that extends transversely to the optical axis along which the excitation light propagates. A cylindrical lens shapes the beam of excitation light into a line beam. An objective lens (or simply “objective”) focuses the line beam onto the object. The same objective is typically utilized to collect the light emitted by the object (emission light), which may have a different wavelength than the excitation light as in the case of fluorescence applications. A beam splitter is optically positioned between the light source and the objective, and between the objective and one or more optical detectors along different optical axes. The beam splitter is configured for separating the excitation light and the emission light, typically by discriminating between the different spectral compositions of the excitation light and the emission light (typically of longer wavelength than the excitation light), such that the beam splitter reflects the excitation light and transmits the emission light. The emission light is transmitted toward and focused onto the detector, which is typically a CCD (charge coupled device) or CMOS (complementary metal oxide semiconductor) imaging sensor that has a linear or two-dimensional array of detecting elements. The detector converts the emission light read by the detecting elements into respective electrical signals that typically are measures of light intensity. A scanning device moves the object relative to the beam of excitation light, or the beam relative to the object, whereby the object is progressively imaged in sections. The image acquisitions performed by the detector are synchronized with the scanning operation. Ultimately, a whole image of the object is constructed by processing electronics.

The line scanning confocal microscope may be of the multi-color type, which utilizes multiple sources of excitation light with different colors to image the object in multiple spectral ranges. The multi-color confocal microscope may be configured for performing sequential multi-color imaging, which entails sequentially selecting one of the available colors of the excitation light and collecting the corresponding emission light at the detector, and repeating this for different colors. Alternatively, the multi-color confocal microscope may be configured for performing simultaneous multi-color imaging. In this case, the microscope includes multiple detectors respectively configured for detecting light of different colors. Known multi-color confocal microscopes configured for simultaneous multi-color imaging do not require sequential interrogation for each color, and thus may be considered as providing a gain in operational throughput in comparison to multi-color confocal microscopes configured for sequential multi-color imaging. However, known multi-color confocal microscopes configured for simultaneous multi-color imaging are complicated and expensive. In addition to requiring multiple detectors, they require a series of beam splitters to separate the emission light into multiple beam components of respectively different colors, and direct the different colored beam components to different respective detectors. Moreover, known multi-color confocal microscopes suffer from the inability to completely separate the emission light into different colors, which results in spectral overlap or cross-talk between different colors in each of the beam components read by the corresponding detectors. This spectral cross-talk is impossible to eliminate completely by spectral filtering. Spectral cross-talk may decrease the signal-to-noise ratio of the microscope, lower the resolution and sensitivity of the microscope and, more generally, reduce the quality of the images produced by the microscope and impair the ability to perform homogeneous assays.

The examples, of one- or multi-color microscope, scanning methods and image acquisitions are described by Benedetti et al (Confocal-line microscopy, Journal of Microscopy, Vol. 165, Pt. 1, JNUey 1992, pp 119-129) and in U.S. Pat. No. 6,388,788 “Method and Apparatus for Screening Chemical Compounds”.

Therefore, there is a need for providing confocal microscopes and imaging methods that reduce or eliminate spectral cross-talk.

### SUMMARY

To address the foregoing problems, in whole or in part, and/or other problems that may have been observed by persons skilled in the art, the present disclosure provides methods, processes, systems, apparatus, instruments, and/or devices, as described by way of example in embodiments set forth below.

According to one implementation, a confocal microscope includes a light source configured for producing excitation light including a plurality of different spectral components; a spectral dispersion device communicating with the light source and configured for outputting the excitation light as a spectrally dispersed beam in which the different spectral components propagate in different respective directions; an optical line generator communicating with the spectral dispersion device and configured for outputting the spectrally dispersed light as an elongated beams with a number of lines having different spectral components; an object holder configured for holding an object to be illuminated; an objective communicating with the optical line generator and configured for focusing the light beams on the object as a plurality of parallel lines of excitation light corresponding to the plurality of different spectral components, wherein the lines of excitation light are spaced apart from each other by a separation distance; and a detector configured for simultaneously detecting a plurality of parallel lines of emission light emitted by the object in response to illumination. In various implementations, the confocal microscope may include a beam expander between the light source and the prism, a collimating lens between the light source and the prism, and/or an optical filter between the light source and the prism.

According to another implementation, a method for imaging an object includes producing excitation light that includes a plurality of different spectral components; producing a spectrally dispersed beams from the excitation light, wherein the different spectral components propagate in different respective directions; focusing the spectrally dispersed beams into elongated region; and illuminating the object by focusing the light of elongated regions as a plurality of parallel lines of excitation light incident on the object, wherein the parallel lines of excitation light correspond to the different spectral components and are spaced apart from each other by a separation distance.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a multi-color confocal microscope according to one implementation disclosed herein.

FIG. 2 is a perspective view of the microscope illustrated in FIG. 1.

FIG. 3 is a side view of the microscope illustrated in FIG. 1.

FIG. 4 is a top view of the microscope illustrated in FIG. 1.

FIG. 5 is a schematic view of a light source that includes a plurality of light source units according to one implementation.

FIG. 6 is a schematic illustration of a multi-color beams of light outputted from an objective according to one implementation.

FIG. 7 is a plan view of an object being illuminated by a plurality of parallel lines from excitation light according to one implementation.

FIG. 8 is a perspective view of the microscope illustrated in FIG. 1, which includes a movable mirror for use in line scanning.

FIG. 9 is a schematic view of an optical detector receiving a plurality of parallel lines of emission light and a process for applying a virtual confocal slit, according to implementations disclosed herein.

### DETAILED DESCRIPTION

Generally, the terms “color,” “wavelength” and “frequency” are used interchangeably herein to refer to a spectral component of light (or electromagnetic energy).

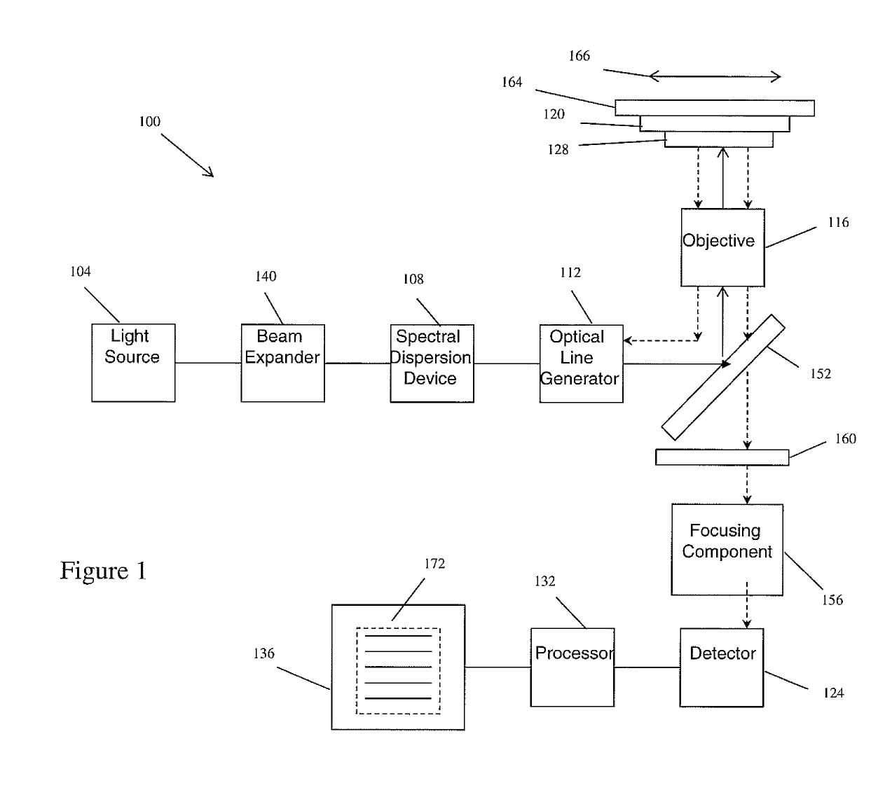

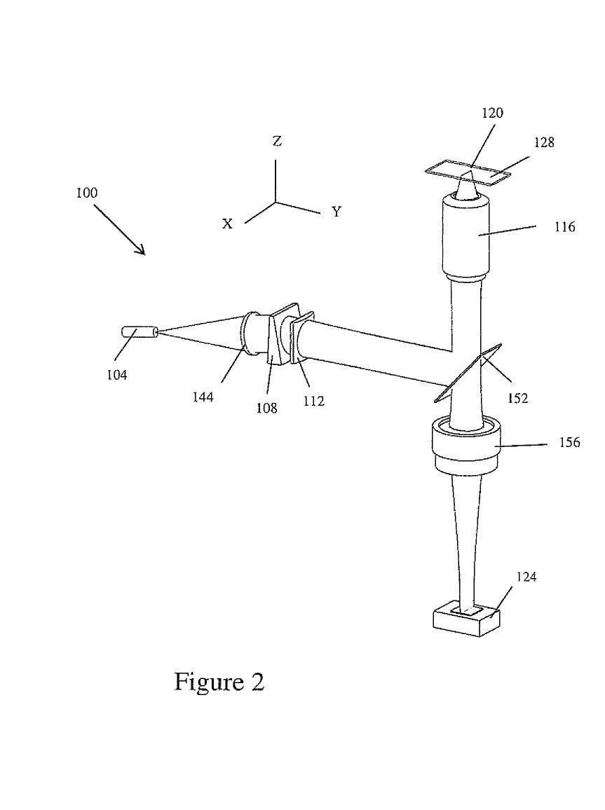

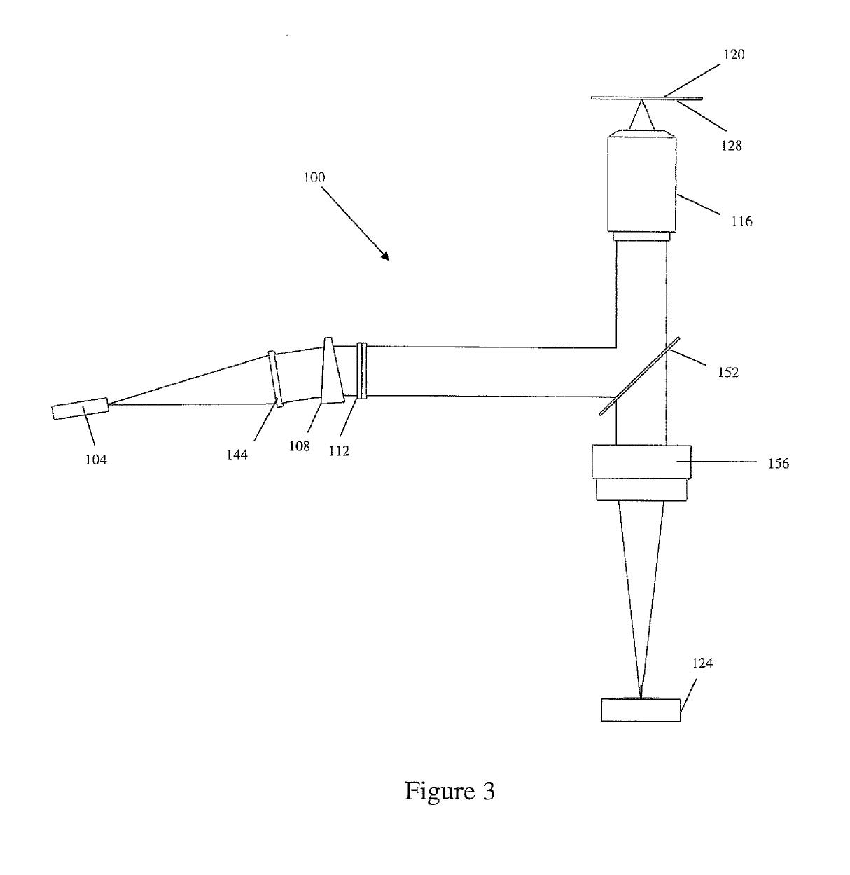

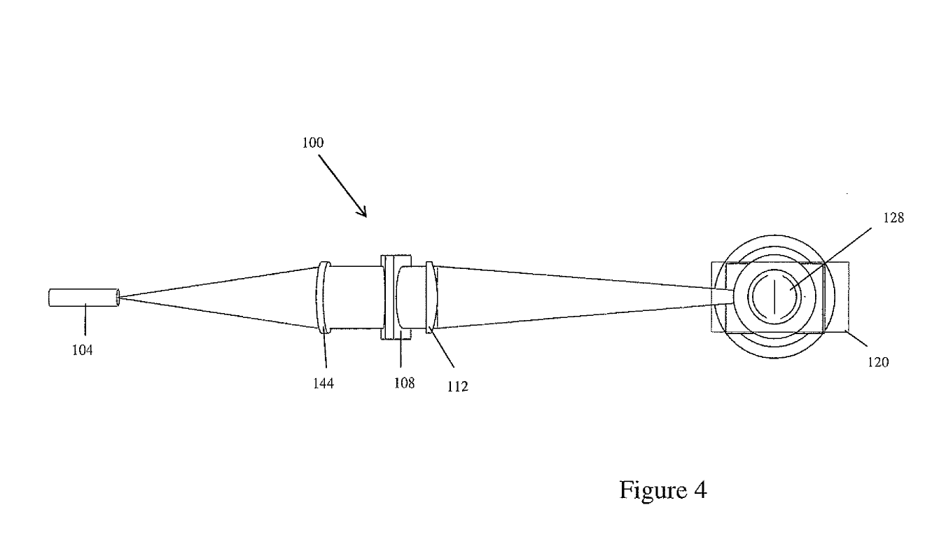

FIG. 1 is a schematic view of an example of a multi-color confocal microscope (or microscopy device apparatus, system or assembly) 100 according to one possible implementation. FIG. 2 is a perspective view of the microscope 100, with certain components shown in FIG. 1 omitted in FIG. 2 for simplicity. FIG. 3 is a side view and FIG. 4 is a top view of the microscope 100.

The microscope 100 may generally include a light source 104 that may be implemented as a single source or as a plurality of light source units, each producing a beam component with at least one of the different spectral components. The microscope further comprises a spectral dispersion device 108 or any optical device outputting the excitation light. The optical device may be constructed from optical fiber components, each delivering a specific wavelengths of light, wherein each of these fibers illuminating light Onto the collimating lens for producing respective parallel beams of lights propagating in different directions. The optical device may also be implemented by utilizing a beam combiner with a number of dichroic mirrors, arranged under specified angles therebetween, or a multiplexer for combining and deflecting a number of light beams, which are generated by a respective number of light sources having different spectral component. The light beams are propagated in different directions at the output of the combiner.

The microscope further comprises an optical line generator that may comprise cylindrical lens or cylindrical mirror 112, an objective lens (or objective) 116, an object holder (or sample holder) 120, and an optical detector (or image sensor) 124. The microscope 100 may also include, as needed or desired, optics between the light source 104 and the spectral dispersion device 108, between the optical line generator 112 and the objective 116, and between the object holder 120 and the detector 124, examples of which are described below. The microscope 100 may also include a scanning device, i.e., a device or means for moving an object or sample 128 having fluorescence property held by the object holder 120 relative to a line beam of excitation light that illuminates (or irradiates) the object 128, and/or for moving the line beam relative to the object 128, examples of which are described below. The microscope 100 may also include a processor 132 and a data output device 136, examples of which are described below. In some implementations, the processor 132 and data output device 136 may be considered to be components separate from the microscope 100.

For illustrative purposes, in FIG. 1 solid arrows represent the optical path(s) of excitation light produced by the light source 104, processed by (or transmitted through) one or more components, and directed to the object 128 to be irradiated. Dotted arrows represent the optical path(s) of excitation light reflected by the object 128 and processed by (or transmitted through) one or more components. Dashed arrows represent the optical path(s) of emission light produced by the object 128 in response to irradiation by the excitation light. To provide a frame of reference and indicate relative directional orientations, FIG. 2 includes an x-y-z coordinate system. The respective directions of the three axes (and thus the orientations of the x-y, y-z and x-z planes) are fixed in arbitrarily selected orientations, but conceptually the frame of reference may be translated anywhere in FIG. 2 along the x-, y- and/or z-directions. From the perspective of this frame of reference, the side view of FIG. 3 lies in the y-z plane and the top view of FIG. 4 lies in the x-y plane. The object 128 and the surface of the object holder 120 supporting the object 128 also lie in the x-y plane.

The light source 104 may be any light source suitable for microscopy and which produces a beam of multi-color excitation light (light having two or more different spectral components). In typical implementations the light source 104 includes one or more lasers. More generally the light source 104 may include, for example, one or more solid-state lasers such as semiconductor diode lasers, optically pumped semiconductor (OPS) lasers, or frequency-doubled diode-pumped solid-state (DPSS) lasers; other types of solid-state lighting devices such as light emitting diodes (LEDs); gas lasers such as Ar-ion, Kr-ion or HeNe lasers; xenon are lamps; metal halide lamps; or incandescent lamps. Any wideband or broadband light source may include optical filters (excitation filters) as needed to output the excitation light at the desired wavelengths. Certain narrowband lasers may likewise need “clean up” excitation filters to block unwanted light. Examples of typical wavelengths of excitation light utilized for microscopy include, but are not limited to, 405 nm, 488 nm, 561 nm, and 645 nm. The excitation light produced by the light source 104 may be coupled to the rest of the system shown in FIG. 1 by free space (i.e., air), or by a suitable light guide such as an optical fiber or a light pipe. The light source 104 may be a single light source capable of producing light with multiple wavelengths. Examples include semiconductor laser modules such as the PMLS II (polarized multi-laser source) product available from Blue Sky Research, Milpitas, Calif., and Point Source laser products available from Qioptiq Photonics Ltd., Hamble, Southampton, United Kingdom. Alternatively, the light source 104 may include a plurality of light source units, each of which produces an excitation light beam having at least one of the spectral components desired for irradiation of the object 128. For example, the light source 104 may include a plurality of lasers or LEDs.

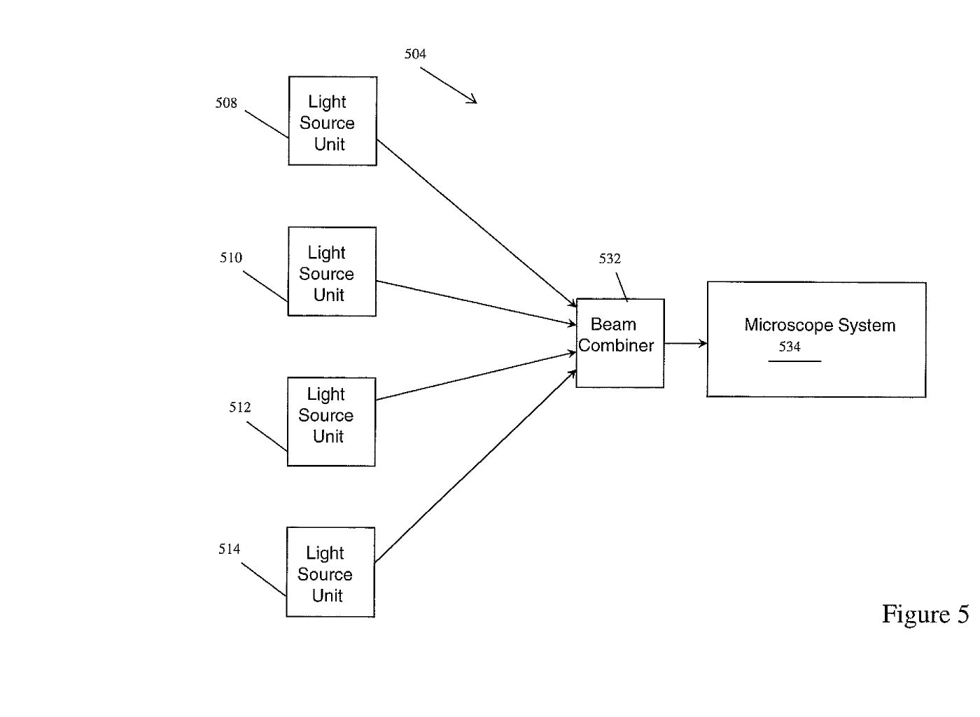

FIG. 5 is a schematic view of a light source 504 that includes a plurality of light source units 508, 510, 512 and 514 (four, by example) according to one implementation. Each light source unit 508-514 produces a light beam (or beam component) having at least one of the spectral components desired for the multi-color excitation light. The respective beams may be combined into a single beam of multi-color excitation light by a beam combiner or multiplexer 532, which outputs the single beam to the rest of the system (block 534) comprising the microscope 100. The beam combiner 532 may be based on, for example, a dichroic or trichroic mirror, or may have any other configuration suitable for combining beams as appreciated by persons skilled in the art. For example, the beam combiner 532 may be implemented as an optical fiber combiner.

The light source 104 may be configured to enable a subset of colors to be selected from a larger number of available colors. In the case of a single light source, this may entail switching on/off selected wavelengths. In the case of a multi-unit light source (e.g., FIG. 5), this may entail switching on/off selected light source units 508-514.

Referring to FIGS. 1 and 2, the multi-color excitation light produced by the light source 104 is transmitted through the spectral dispersion device 108. In some implementations, the excitation light may first be transmitted from the light source 104 through a beam expander 140 (FIG. 1) to expand the size of the excitation light beam to match the size of a pupil of objective 116 (e.g., 20 mm in diameter). As one example, the beam expander 140 may include one or more lenses producing collimated light. The beam expander 140 may be positioned between the light source 104 and the spectral dispersion device 108, or between the beam expander 140 (if included) and the spectral dispersion device 108. The spectral dispersion device 108 may be any device suitable for dispersing the different spectral components of the excitation light such that the different spectral components respectively propagate in different directions. As one example, the spectral dispersion device 108 may be an appropriately configured dispersive prism. As another example, an appropriately configured diffraction grating may be suitable as the spectral dispersion device 108. In typical implementations, the different spectral components outputted from the spectral dispersion device 108 propagate in only slightly different directions (or at small angles relative to each other). In the case of a dispersive prism, this is a result of the different spectral components traveling at different speeds, with longer wavelengths being refracted less than shorter wavelengths. The output of the spectral dispersion device 108 may be characterized as a spectrally dispersed beam of excitation light.

As best shown in FIG. 2, the spectrally dispersed beam is transmitted from the spectral dispersion device 108 and through the optical line generator 112 along the y-direction. The optical line generator 112 is configured and oriented such that it has a flat input side lying in the x-z plane, and an opposing concave output side. The spectrally dispersed beam typically has a generally circular cross-section up to the point it reaches the flat side of the optical line generator 112. The optical line generator 112 is configured such that it focuses the spectrally dispersed beam in one dimension, i.e., as a thin line which in the illustrated example lies in the y-z plane. One non-limiting example of a suitable line generation is cylindrical lens that is available as model no. 46019 from Edmund Optics Inc., Barrington, N.J. The output of the optical line generator 112 may be characterized as a spectrally dispersed line beam.

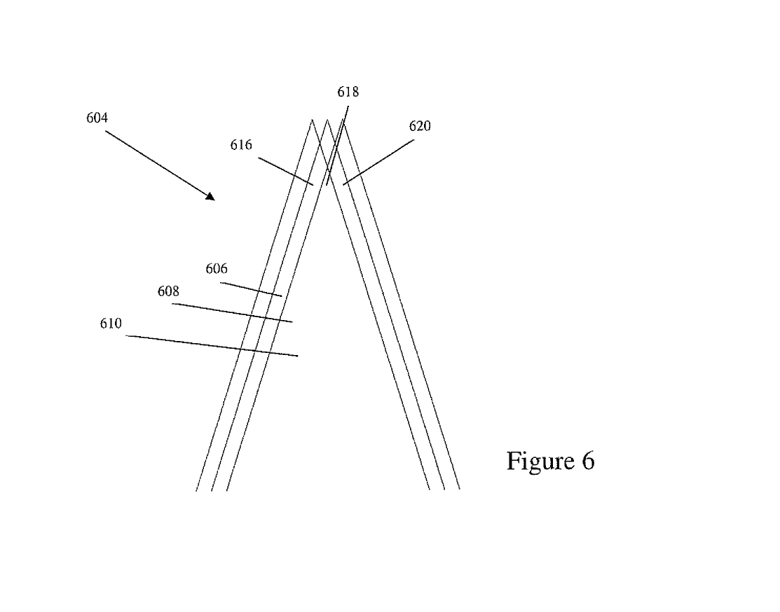

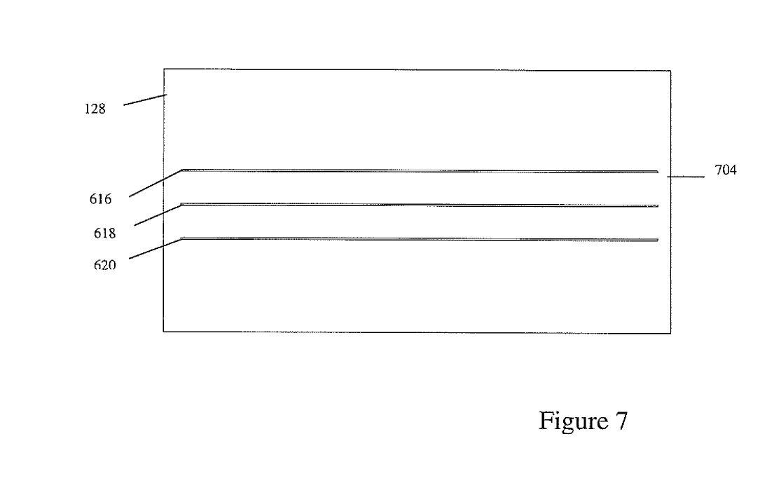

The different spectral components of the line beam are directed to the objective 116 at (typically slightly) different angles of incidence. This enables the beam of light illuminating a line to be focused by the objective 116 as a plurality of parallel, spaced-apart lines of excitation light (excitation lines) on the object 128, with each excitation line being separated from adjacent excitation lines in proportion to the angles of incidence of the different spectral components of the line beam. Each excitation line corresponds to one of the spectral components; that is, the parallel excitation lines are different colors. FIG. 6 is a schematic illustration of a line beam 604 outputted from the objective 116 along X axis. In this example, the line beam 604 includes three spectral components 606, 608 and 610 although in other examples may include less than three or more than three spectral components. The first spectral component 606 has a first wavelength, the second spectral component 608 has a second wavelength different from the first wavelength, and the third spectral component 610 has a third wavelength different from the first and second wavelengths. The objective 116 focuses the three spectral components 606, 608 and 610 as excitation beam illuminating three parallel lines 616, 618 and 620 spaced apart from each other. FIG. 7 is a planar top view of the object 128 along Z axis (or a region of the object 128) being illuminated by excitation beam with three parallel lines 616, 618 and 620, each having different wavelength. In some implementations, the spacing (or separation distance) between the lines is on the order of microns, for example ranging from one or more tens of microns to one or more hundreds of microns. In some implementations, the spacing between the lines ranges from about 1 to 500 μm. Typically, the length of the lines is substantially greater than their separation distance. The length of the lines may span the entire length (or substantially the entire length) of the field of view of the microscope.

The objective 116 may have any configuration suitable for irradiating the object 128 as just described. For example, the objective 116 may include a (typically cylindrical) housing that supports one or more lenses, mirrors and/or other optical components. The objective 116 and the object 128 are positioned at a distance from each other such that the object 128 lies in the focal plane of the objective 116. As one non-limiting example, the distance between the objective 116 and the object 128 may range starting from 30 mm and approaching 0. The objective 116 may be configured to enable adjustment of the length of the lines. For example, the length of the lines may be adjusted to be equal (or substantially equal) to the size of the field of view by selecting the property of the beam expander.

In response to irradiation by the excitation light, the object 128 emits emission light in form of parallel, spaced-apart lines from the object. As in the case of the excitation light emitted from different parallel lines on the object, the parallel emission lines respectively correspond to different spectral components. In a typical implementation entailing fluorescence microscopy, each line of emission light has a longer wavelength than its corresponding line of excitation light. The emission light from illuminated lines may be directed and focused onto the detecting elements of the detector 124 by any suitable apparatus or means, an example of which is described below. To improve resolution and signal-to-noise ratio, excitation light reflected from the object 128, which conventionally propagates at a higher intensity than the emission light, may be attenuated, rejected or otherwise isolated from the emission light by any suitable apparatus or means, examples of which are described below. The detector 124 may be any photo detector or photo sensor suitable for microscopy and capable of simultaneously detecting (or reading or sensing) the multiple lines of emission light emitted from the object 128. For this purpose, in typical implementations the detector 124 includes a two-dimensional array of detecting elements such that each line of emission light is detected by a respective one of the rows of detecting elements. Examples of suitable detectors include, but are not limited to, APS (active-pixel sensor) devices such as CMOS (complementary metal-oxide semiconductor) image sensors and related devices, CCD (charge-coupled device) image sensors and related devices, and image sensors featuring hybrid CCD/CMOS architectures, for example scientific CMOS (sCMOS) image sensors such as those available from Fairchild Imaging, Milpitas, Calif.

FIGS. 1 to 3 illustrate a typical implementation of the microscope 100 (e.g., an epi-fluorescence configuration) in which the objective 116 is utilized not only as a condenser to project the excitation light onto the object 128 but also to collect the resulting emission light from the object 128. In this implementation, the objective 116 focuses the excitation light onto the object 128 in the normal direction which, from the perspective of FIGS. 2 and 3 is the z-direction perpendicular to the x-y plane in which the 128 object is supported. An optical beam splitter 152 is positioned in a first optical path A associated with the output of excitation light from the spectral dispersion device 108 and optical line generator 112 (i.e., along the y-axis, from the perspective of FIGS. 2 and 3). The beam splitter 152 is also positioned in a second optical path B orthogonal to the first optical path A (i.e., along the z-axis, from the perspective of FIGS. 2 and 3), which is associated with the output of excitation light from the objective 116 to the object 128 and the transmission of emission light from the objective 116 to the detector 124. The beam splitter 152 is thus positioned between the objective 116 and the detector 124 in this example. The beam splitter 152 is configured to reflect light at wavelengths typically associated with excitation light and to transmit light at wavelengths typically associated with emission light. By this configuration, and with the orientation of the beam splitter 152 shown by example in FIGS. 2 and 3, excitation light from the optical line generator 112 is deflected by the beam splitter 152 toward the objective 116 and object 128, and excitation light reflected from the object 128 is transmitted back through the objective 116 and deflected by the beam splitter 152 back toward the optical line generator 112. Also, emission light from the object 128 is transmitted through the objective 116 and allowed to pass through the beam splitter 152 and propagate toward the detector 124. The beam splitter 152 may be any device suitable for blocking excitation light and passing emission light such as, for example, a dichroic mirror, spectral beam splitter or geometric beam splitter, for example, with semi-reflective coating.

In implementations where the objective 116 is configured to focus the emission light at infinity, the microscope 100 may additionally include an optical focusing component 156 configured for forming a real image of the object 128 (i.e., the parallel emission lines) that is focused on the detector 124. The detector 124 may be positioned from the focusing component 156 at a distance at which the array of detecting elements lies in the focal plane of the focusing component 156. As one non-limiting example, the distance between the focusing component 156 and the detector 124 may range from 50 mm to 250 mm. As one example, the focusing component 156 may be a tube lens. The tube lens may, for example, include a housing that supports one or more lens, mirrors and/or other optical elements The objective 116 and focusing component 156 are producing an image of the illuminated line on the object 128 and the image is shaped as a line onto the detector 124. In some implementations, one or more optical filters 160 (FIG. 1) may be positioned between the beam splitter 152 and the detector 124 (or between the beam splitter 152 and the focusing component 156, if provided) to further attenuate or assist in eliminating the excitation light from the light beam that is incident on the detector 124. Examples of optical filters include, but are not limited to, various types of coated substrates such as notch or multi-notch filters available from Semrock, Inc., Rochester, N.Y. An additional filter having different spectral properties for each line of emission light may be added in front of the detector 124. This type of filters, in some implementation may allow for elimination of optical filter 160.

As shown in FIG. 7, the set of parallel lines 616, 618 and 620 illuminated by beams of excitation light illuminate only a portion of the object 128. The area of the object 128 illuminated by the lines 616, 618 and 620 at a given instance of time may be characterized as being one section or region of interest 704 of the object 128, and the full area of the object 128 may be characterized as being the sum of several regions of interest. Thus, the use of the set of parallel lines facilitates acquiring a full image of the entire object 128 by a line scanning technique. Line scanning may be done by either moving (e.g., in the direction orthogonal to the lines 616, 618 and 620) the object 128 relative to the lines 616, 618 and 620, or moving the lines 616, 618 and 620 relative to the object 128, or both. Line scanning of either type may be effected by any suitable scanning device or means. As one example, FIG. 1 illustrates the object holder 120 mechanically communicating with a motorized stage 164 that is movable in one or two dimensions, with one direction indicated by an arrow 166 and the other direction running into and out from the drawing sheet (or in the x- and y-directions from the perspective of FIG. 2). The object holder may be connected to or integrated with a scanning device. Scanning device may be implemented as a stage capable of moving the object holder, or a mirror configured for deflecting the beams or as acusto-optical deflector.

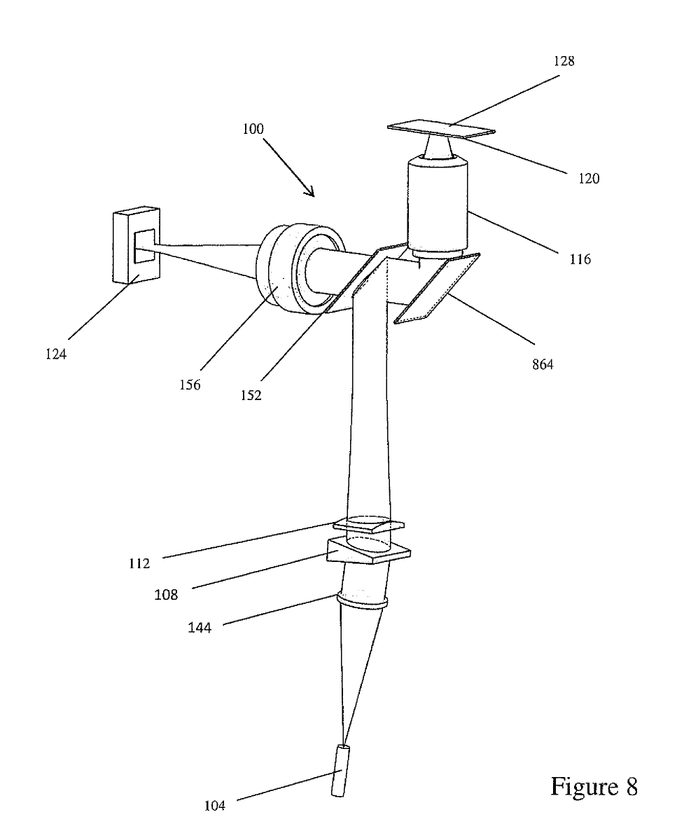

As another example, FIG. 8 is a perspective view of the microscope 100, which includes a movable (e.g., rotatable) mirror 864 interposed in the optical path between the beam splitter 152 and the objective 116. The mirror 864 is configured to reflect both excitation light and emission light. The mirror 864 is moved (actuated) by any suitable device (e.g., a galvanometer, not shown). Movement of the mirror 864 changes the angle of reflection of light, thereby enabling the excitation light to be moved relative to the object 128.

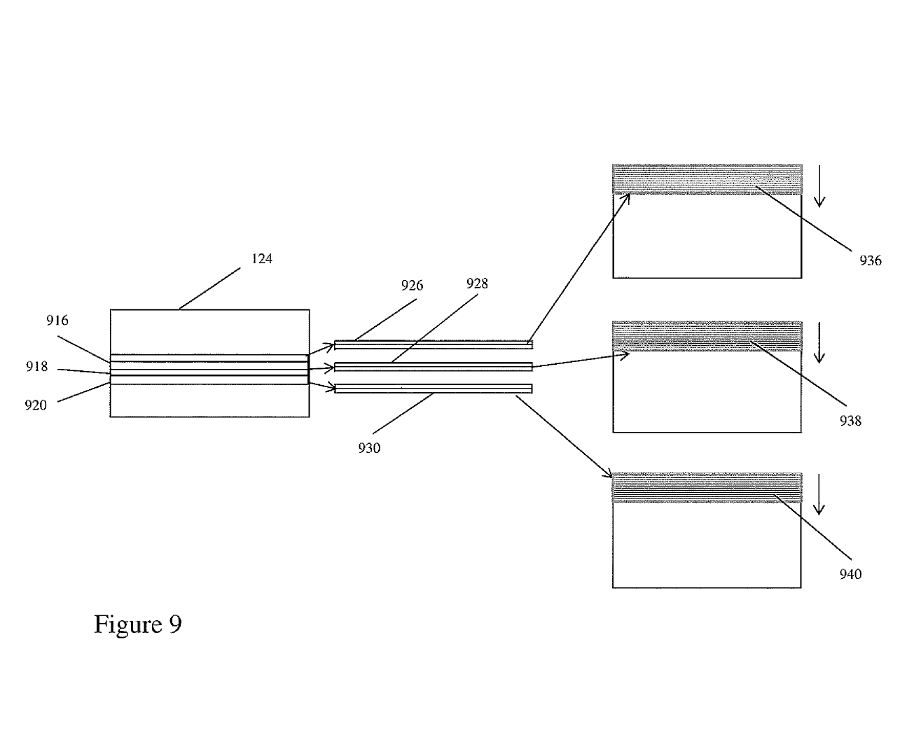

FIG. 9 is a schematic view of the optical input side of the detector 124 where the array of detecting elements is located. An image of the object 128 is created (e.g., by the objective 116, or by the objective 116 in combination with the focusing component 156 on the detector 124. The image comprises a set of parallel lines generated by the illuminated object 128 as described above. In this example, the image includes three lines 916, 918 and 920 of emission light (respectively corresponding to three different spectral components) although in other examples may include less than three or more than three lines. The first line 916 (spectral component) has a first wavelength, the second line 918 (spectral component) has a second wavelength different from the first wavelength, and the third line 920 (spectral component) has a third wavelength different from the first and second wavelengths. In some implementations, the spacing (or separation distance) between the lines is on the order of microns, for example ranging from one or more tens of microns to one or more hundreds of microns. Typically, the length of the emission lines is substantially greater than their separation distance. The spacing between the lines may be 10 to 1000 times smaller than the length of the emission lines. As one example, the length may be 4000 μm and the separation distance may be 40 μm, therefore the ratio would be 100:1. The spacing between these lines are corresponding to the spacing between lines 616, 618 and 620 and depends on the magnification of the microscope. The narrow width of the image shown in FIG. 9 enables utilizing the detector 124 for region-of-interest readout as opposed to full-area readout, and thus progressive line-by-line scanning of the object 128 as noted above. When implementing line scanning, the image may be referred to as a “region-of-interest” image. The size of the region-of-interest image may vary. Generally, the smaller the region of interest the faster it can be read by the detector. As one example, the size of the region-of-interest image may be 2560×170 pixels, which may be read by a suitable detector at a rate of, for example, 1800 fps (frames per second). When implementing line scanning, data may be acquired at each scan position. The arbitrarily located set of illuminated lines 616, 618 and 620 in FIG. 7 and resulting set of lines 916, 918 and 920 of emission light in FIG. 9 correspond to one scan position, and may correspond to one frame of captured data. In other words, at each scan position, the lines illuminate the region of interest on the object 128 and the detector 124 captures the image of the lines resulting from that illumination. The scan position is then advanced between frames (by moving the object 128 relative to the excitation light or vice versa, as described above), and a different region of interest is irradiated and imaged on the detector 124. The scanning process may be repeated, with each subsequent frame capturing the emission light from the corresponding region of interest, until a full image of the object 128 is acquired. Scanning may be done in either a step-wise or continuous manner.

Because data is acquired from each emission line separately, a like number of different full images of the object 128 may be acquired, with each full image based on (or derived from) the specific spectral component associated with that line of emission light. Thus, in the example of FIGS. 7 and 9, three full images of the object 128 may be constructed by scanning the object 128 with the three parallel lines 616, 618 and 620 of excitation light and acquiring the data represented by the lines 916, 918 and 920 of emission light during each scanning iteration. In fluorescence applications, the three different images may correspond to the responses of three different fluorophores in the object 128 to irradiation by the excitation light at the three different wavelengths.

It will be noted that at each different scan position, the lines irradiating the object 128 are spatially separate by an appreciable distance. This enables the detector 124 to receive and process distinct lines of emission light separately. As a result, there is no spectral overlap or cross-talk between different colors. Moreover, only a single detector 124 is needed, and multiple beam splitters are not needed.

In some implementations, the imaging data acquired by the detector 124 is processed so as to produce simulated, or “virtual,” confocal slit-scanned images with adjustable widths of the “virtual” slit. Referring to FIG. 9, at each scan position the region-of-interest image is subdivided into a plurality of sub-regions (or sub-images) 926, 928 and 930, with each sub-region 926, 928 and 930 containing a respective line 916, 918 and 920 of emission light. That is, the sub-regions 926, 928 and 930 are associated with different colors. In each of the sub-regions 926, 928 and 930 the virtual confocal slit is applied by summing the number of pixels perpendicular to each of the lines. Therefore the width of the virtual slit is defined by the number of summed pixels multiplied by the distance between pixels or pixel pitch, and the width of the slit that is defined by the number of pixels summed is determined by the desired degree of confocality. For the highest degree of confocality, the number of pixels summed is equal to one, i.e., a single row of pixels. At a value of one, the number of pixels summed corresponds to the virtual confocal slit having the narrowest width, which is associated with the highest degree of out of focus light rejection but lowest sensitivity. Increasing the number of pixels summed increases the width of the virtual confocal slit, resulting in decreased confocality and increased sensitivity. Accordingly, the effect of changing the width of the virtual slit is somewhat analogous to effect of changing the physical size of a pinhole or slit in a conventional confocal microscope, where there is tradeoff between confocal sectioning and emission light intensity. Summing the emission light results in a plurality of sets 936, 938 and 940 of one-dimensional arrays (rows) of pixels, one set 936, 938 and 940 for each color. This process may be repeated at each scan position, generating a plurality of sets of one-dimensional pixel arrays, again for each color. For each color, the plurality of sets of one-dimensional pixel arrays may be processed to construct a full two-dimensional image of the object 128. In this manner, full images of the object 128 are produced in each of the colors of the emission light, with image quality optimized as desired by selecting the width of the virtual slits applied for each color. Because the virtual slits are based on the distinct lines of the emission light received and processed by the detector 124, there is no spectral overlap or cross-talk between different colors.

Referring to FIG. 1, the microscope 100 may include, or be in operative communication with, a processor or controller 132 (e.g., a computing device) communicating with an output of the detector 124, and an output device 136 communicating with the processor 132. Communication between these components may be done via any suitable wired or wireless communication link, as appreciated by persons skilled in the art. The processor 132 may be any (typically electronic processor-based) device configured for receiving the imaging data outputted by the detector 124, and processing the data as needed to construct images of the object 128 being interrogated by the microscope 100, which in some implementations includes applying a virtual confocal slit as described above. The processor 132 may also be configured for controlling (e.g., switching on/off, adjusting, timing, synchronizing, monitoring, measuring, etc.) the operations of one or more components of the microscope 100, such as the light source 104, scanning device (e.g., stage 164 in FIG. 1 or mirror 864 in FIG. 8), movable filter sets (not shown), etc. The processor 132 may also be configured for formatting the processed imaging data as needed to enable the display of user-readable images by the output device 136. For any such purposes, the processor 132 may include one or more hardware (or firmware) modules, software modules, memory modules (e.g., for storing data acquiring by the detector), and databases as appreciated by persons skilled in the art. For example, the processor 132 may include a main processor (or processing unit) providing overall control of the microscope 100, and one or more other processors (or processing units) configured for dedicated control operations or specific signal processing tasks. Moreover, the processor 132 may include a computer-readable medium that includes instructions for performing all or part of any of the methods disclosed herein.

The processor 132 schematically illustrated in FIG. 1 may also be representative of one or more types of user interface devices, such as user input devices (e.g., keypad, touch screen, mouse, and the like), user output devices (e.g., display screen, printer, visual indicators or alerts, audible indicators or alerts, and the like), a graphical user interface (GUI) controlled by software for display by the output device 136, and one or more devices for loading media readable by the processor 132 (e.g., logic instructions embodied in software, data, and the like). The processor 132 may include an operating system (e.g., Microsoft Windows® software) for controlling and managing various functions of the processor 132. One or more components of the processor 132 may be located remotely from the microscope 100 and communicate with the local portion of the processor 132 over a wired or wireless communication link. FIG. 1 also schematically depicts the output device 136 as including a display screen 172 on which a digitized (e.g., rasterized) image of the object 128 is presented. The output device 136 may include other types of output modules such as a printer, a device for writing or storing data on electronic media (e.g., compact disk), etc.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the processor 132 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), or application specific integrated circuits (ASICs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the processor 132 in FIG. 1), direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A confocal microscope, comprising:
a light source configured for producing excitation light comprising a plurality of different spectral components;
an optical device communicating with the light source configured for obtaining an excitation light with a spectrally dispersed beam having different spectral components propagating in different respective directions and outputting the components as a number of beams elongated in a direction transverse to the propagation of the excitation light;
an object holder configured for holding an object to be illuminated;
an objective communicating with the optical device and configured for focusing the number of elongated beams on the object as a plurality of parallel lines of excitation light corresponding to the plurality of different spectral components, wherein the lines of excitation light are spaced apart from each other by a separation distance; and
a detector configured for simultaneously detecting a plurality of parallel lines of emission light emitted by the object in response to illumination by the lines of the excitation light.

2. The confocal microscope of claim 1, wherein the optical device further comprising a spectral dispersion device and an optical line generator communicating therewith.

3. The confocal microscope of claim 2, wherein the light source comprises a plurality of light source units, each light source unit configured for producing a beam component comprising at least one of the different spectral components, and further comprising a beam combiner between the light source units and the spectral dispersion device for outputting a spectrally dispersed beam into a number of elongated beams of the excitation light.

4. The confocal microscope of claim 1, comprising an optical component configured for focusing the lines produced by the emission light onto the detector.

5. The confocal microscope of claim 1, comprising a beam splitter between the object holder and the detector and configured for separating the emission light from excitation light.

6. The confocal microscope of claim 5, comprising an optical filter between the beam splitter and the detector and configured for separating the emission light from excitation light.

7. The confocal microscope of claim 1, further comprising a processor configured for producing images of the object from one or more of lines produced by emission light.

8. The confocal microscope of claim 1, comprising a scanning device configured for moving at least one of the object holder and the line beam relative to the other.

9. The confocal microscope of claim 8, wherein the scanning device is selected from the group consisting of: an acousto-optic deflector, a stage configured for moving the object holder, and a mirror configured for deflecting the line beam.

10. The confocal microscope of claim 8, wherein the scanning device is configured for moving to a plurality of different scan positions, the detector is configured for simultaneously detecting a plurality of lines of light emitted by the object at each scan position, and further comprising a processor configured for producing the images of the object, wherein each image is produced from lines generated by emission light detected at the different scan positions that have the same spectral component.

11. The confocal microscope of claim 8, wherein each scan position is subdivided into a plurality of sub-regions, each comprising a respective line of emission light for producing a simulated confocal slit, which is applied by summing a signal from a number of pixels perpendicular to each of the line.

12. The method for imaging an object, the method comprising:
(a) producing excitation light comprising a plurality of different spectral components;
(b) producing a spectrally dispersed beams from the excitation light, wherein the different spectral components propagate in different respective directions;
(c) illuminating the object by focusing the elongated beams as a plurality of parallel lines of excitation light incident on the object, wherein the parallel lines of excitation light correspond to the different spectral components and are spaced apart from each other by a separation distance.

13. The method of claim 12, wherein the separation distance ranges from 1 to 500 μm

14. The method of claim 12, wherein, in response to illuminating the object of (c), the object emits emission light from a plurality of parallel lines corresponding to a plurality of different spectral components incident onto the object, and further comprising (d) simultaneously detecting the light emitted from the lines illuminated onto the object.

15. The method of claim 14, wherein simultaneously detecting the emission light comprises operating a single detector.

16. The method of claim 14, comprising producing at least two images of the object from detected emission light emitted from at least two lines illuminated onto the object, the detected light produced by lines of emission light having different spectral components.

17. The method of claim 14, wherein steps (c), and (d) occur at an initial scan position; and further comprising (f) scanning the object at one or more additional scan positions by moving at least one of the object and the elongated beams of excitation light relative to the other in a direction perpendicular to the elongation of the beams, and repeating steps (c), and (d) one or more times at the one or more additional scan positions.

18. The method of claim 17, comprising producing at least two images of the object, wherein each image is produced from light emitted from the lines on the object detected at the respective scan positions that have the same spectral component.

19. The method of claim 18, further comprising subdividing the scan position into a plurality of sub-regions, each comprising a respective line of emission light for producing a simulated confocal slit and applying the simulated confocal slit by summing a signal from a number of pixels perpendicular to each line of emission light.
